(19) United States
(12) Patent Application Publication
(10) Pub. No.: US 2010/0246182 A1
(43) Pub. Date: Sep. 30, 2010

(54) SPRING SLOT&LOCK QUICK-CHANGE GOBO CHANGER SYSTEM

(75) Inventor: Pavel JURIK, Postredni Becva (CZ)

Correspondence Address: HEINZ GRETHER PC;G2 Technology Law, P.O. Box 202858, AUSTIN, TX, 78720, US

(73) Assignee: ROBE LIGHTING

(21) Appl. No.: 12/749,690

(22) Filed: Mar. 30, 2010

Related U.S. Application Data
(60) Provisional application No. 61/165,253, filed on Mar. 31, 2009.

(51) Int. Cl. F21V 17/02; F21V 11/00

(52) U.S. Cl. 362/277; 362/311.01

(57) ABSTRACT

For lighting equipment for illumination of theatre and show stages and platforms there is designed equipment for quick change of rotary gobos comprising a carrier disc supporting interchangeable segments with the gobos. The individual segments are attached at the carrier disc by springs which register the position of the segment on the gobo carrier while at the same time holding the segment in place.

### RELATED APPLICATION(S)

This application is a utility filing claiming priority of provisional application 61/165,253 filed on 31 Mar. 2010.

### TECHNICAL FIELD OF THE INVENTION

The invention relates to equipment for a change of rotary gobos furnished with a carrier disc supporting interchangeable segments with the gobos.

### BACKGROUND OF THE INVENTION

The expression gobo relates to an image which is to be projected as a slide within a comparatively great distance. Due to a high temperature of the respective light source such an image is typically created on a metal, glass or any suitable base. To increase the achieved effect the gobos rotate, as a moving image attracts more attention than a stationary image. Rotary gobos need not rotate continuously; therefore their rotation depends upon activation of a drive motor. Typically these systems are configured on a circular carrier with a central sun gear surrounded by planetary gears which rotate the gobo when the sun gear rotates. The figures described below illustrate the planetary gears but not the sun gear. In some such systems the planetary gears are rotated by a gear on the periphery of one or more of the planetary gears. In some such systems gears are not employed at all, the rotation is accomplished by friction or belts. In other systems a combination of belts and gears are used.

Generally speaking there exist two basic types of changeable gobo rotary gobo systems, which are applied with minor or major divergences. By the first system gobos are placed on a carrier disc and the gobos themselves are exchanged. Such a system is technologically simple and cheap, but from a practical point of view it is very cumbersome. In general a lighting equipment designs offer very little working space for any manipulation and often special tools are necessary. This simple design is used preferably for cheap equipment.

In the second type of system, the carrier disc is furnished with mutually independent segments, one segment for each gobo. In order to change the gobo in these systems complete segments are exchanged. In most cases each segment has a special bearing with grooves matching with counter-pieces on the carrier disc. The design of these systems is very demanding on manufacturability of the system. It is an object of the invention to simplify the design of attachment of gobos at the carrier disc and to simplify and speed up gobo changing procedures.

The foregoing problems are solved by equipment design for a rotary gobos drive comprising a carrier disc supporting interchangeable gobo holding segments in accordance with the present invention. The individual segments being attached at the carrier disc by central holding means, each segment being provided with means for in a non-fixed manner registering the position of the segment on the carrier disc. Further in accordance with the present invention each segment may be provided with a lamella for attachment in the central holding means. In a preferred embodiment the central holding means comprise a system of flexible fingers in a fan-shaped arrangement. The fingers are at inside ends fixed to the carrier disc and on the outside free ends adapted to allow for insertion of the segment lamellas between the fingers and the carrier disc. The fingers may be at their inside ends integrated into one unit. The number of fingers within the unit corresponds to a number of segments to be supported by the carrier disc. Still further in accordance with the invention each segment is provided with a bearing supporting a driver with a gobo. The bearing inside ring is provided for by the driver outer rim and the bearing outside ring is attached to the segment lamella by dismountable connection means. The driver further comprises a flange with a spur toothing, designed for engaging with a mechanism for rotation of the gobos. Dismountable connection means for attachment of the bearing outer ring on the lamella may be preferably utilized as means for attaching the segment on the carrier disc. The carrier disc may be further provided with circular apertures allowing for lighting of gobos, the apertures having their centres located at a common pitch circle and being along own perimeter provided with means for engaging with means for registering the position of the segments on the carrier disc.

According the first aspect of the invention provides a simple seating of a segment with gobos on the carrier disc and for changing of the gobos in a very simple and easy procedure. According to another aspect of the invention the presented solution is also technologically simple with little manufacturing costs.

### BRIEF DESCRIPTION OF THE DRAWINGS

By way of examples the invention will be now described with reference to the accompanying drawings:

FIG. 1 illustrates an axonometric view from above on a carrier disc with seven segments, one of which is in an outside position;

FIG. 2 illustrates an axonometric view from underneath on the carrier disc according to FIG. 1;

FIG. 3 illustrates an axonometric view on one segment in a disassembled state;

FIG. 4 illustrates an axonometric view on a carrier disc supporting six segments;

FIG. 5 illustrates an axonometric view on a carrier disc with five segments;

FIG. 6 illustrates an axonometric view of a further embodiment;

FIG. 7 illustrates an axonometric view from underneath the carrier disc shown in FIG. 6;

FIG. 8 illustrates an axonometric view of a single removable segment with the rotating gobo carriage mounted thereto;

FIG. 9 illustrates a cross section of a segment and the carrier;

FIG. 10 illustrates an axonometric view of a further embodiment;

FIG. 11 illustrates an axonometric view from underneath the carrier disc shown in FIG. 10;

FIG. 12 illustrates an axonometric view of a single removable segment;

FIG. 13 illustrates an axonometric view of a single segment mounted on the carrier disc;

FIG. 14 illustrates an axonometric view of a further embodiment;

FIG. 15 illustrates an axonometric view from underneath the carrier disc; shown in FIG. 14;

FIG. 16 illustrates an axonometric view of a further embodiment;

FIG. 17 illustrates an axonometric view from underneath the carrier disc shown in FIG. 16;

FIG. 18 illustrates an elevation of a single removable segment;

FIG. 19 illustrates an axonometric view of a further embodiment;

FIG. 20 illustrates an axonometric view from underneath the carrier disc shown in FIG. 19;

FIG. 21 illustrates an axonometric view of a single removable segment in a disassembled state; and

FIG. 22 illustrates an axonometric view of the single removable segment shown in FIG. 21.

### DESCRIPTION OF PREFERRED EMBODIMENTS

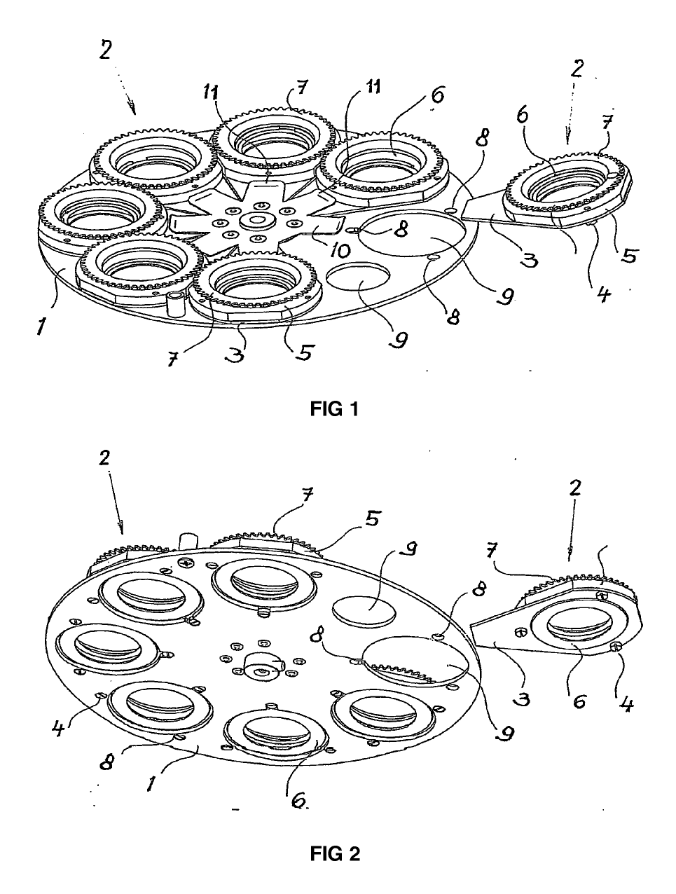

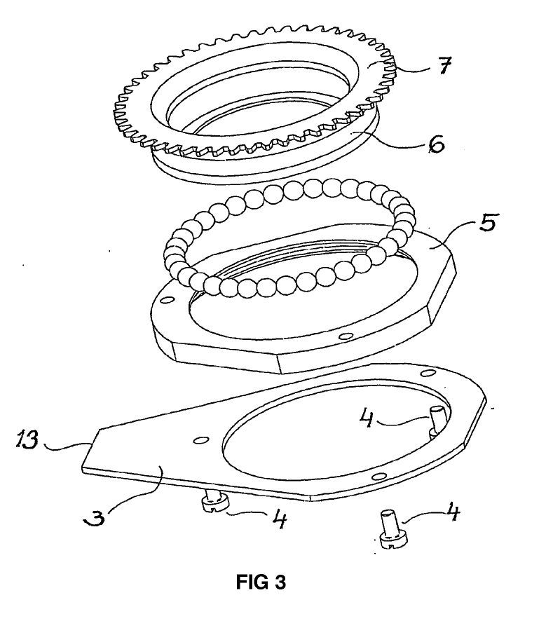

FIG. 1 illustrates equipment for a change of rotary gobos comprising a carrier disc 1 on which there are arranged interchangeable segments 2 with gobos mounted thereon. On all accompanying drawings gobos are presented simply as blank fields. In the embodiment presented on FIG. 1 the carrier disc 1 is equipped with seven segments 2 and one free position, which serves for direct illumination by light.

All segments 2 are by central holding means 10 attached at the carrier disc 1. A part of each segment 2 is made of a lamella 3, shaped for attachment of the segment 2 in the central holding means 10. The gobo is fixed in a rotating gobo carriage driver 6 seated in ball bearing. Fixed connection means, like screws 4 with cylindrical head in the depicted embodiment, serve for securing a ball bearing outside ring 5 on the lamella 3 of each segment 2. The bearing balls are freely located in the bearing outside ring 5, while the bearing inside ring is provided for by a driver 6 outer rim. The driver 6 seating is thus of a very simple design when compared with a standard ball bearing arrangement, nevertheless the function of a rotary gobo is fully retained. The driver 6 is provided with a flange 7 having a spur toothing/teeth for engagement with a mechanism for rotation of the gobos.

The carrier disc 1 is provided with apertures 9, the centers of which are placed on a common pitch circle. The apertures 9 allow for a light beam to go through the gobos or just through the carrier disc 1, as the case may be.

Each segment 2 is provided with means for registering the position of a segment 2 on the carrier disc 1. Preferably the means for registering the position of a segment 2 on the carrier disc 1 are provided for by the bearing connection means 4 for attachment of a ball bearing outside ring 5 on the lamella 3. In the discussed embodiment the means for registering the position of a segment 2 on the carrier disc 1 are provided for by the cylindrical heads of the screws 4. To achieve a proper position of the segment 2 on the carrier disc 1 the screw 4 heads match with recesses 8 made along a perimeter of respective aperture 9 in the carrier disc 1. In the embodiment shown on FIG. 1 and FIG. 2 there are used three screws 4 for each segment 2 and therefore each aperture 9 has three recesses 8 distributed along its perimeter and spaced apart with respect to distribution of the screws 4. There may be used a different number of the screws 4, but basically two of them are sufficient. Instead of the above described construction the means for registering the position of a segment 2 on the carrier disc 1 may be provided for also by another means known as such.

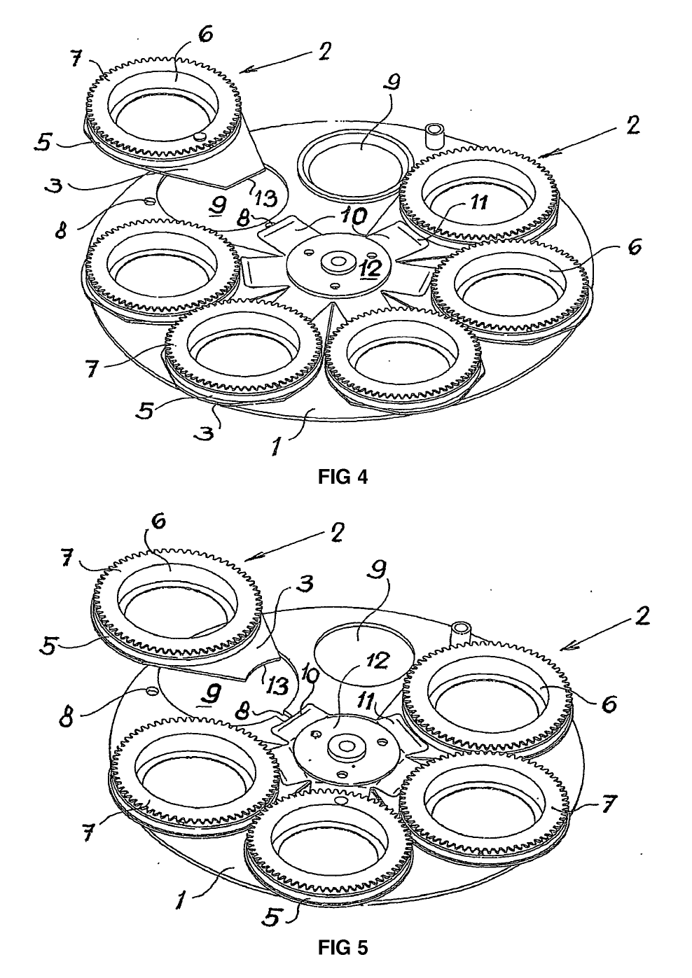

The central holding means 10 comprise a system of radially extending flexible fingers 10 in a fan-shaped arrangement. The fingers 10 are at inside ends attached to the carrier disc 1, preferably by rivets, and on the outside free ends 11 bent upwards to facilitate insertion of segment lamellas 3 between the fingers 10 and the carrier disc 1 body. The number of fingers 10 corresponds to the number of the segments 2, but it is possible for one finger 10 to secure position of more than one segment 2. Preferably the inside ends of all the fingers 10 are integrated into one piece. In a place corresponding to a free position on the carrier disc 1 there is no finger 10 and the space is kept free. To improve pressing forces produced by the central holding means upon the segment 2 lamellas 3 the fingers 10 may be provided with a pressure disc 12 located in their central part common for all the fingers 10, as presented on FIG. 4 and FIG. 5.

To further facilitate insertion of the segment lamella 3 under the finger 10 of the carrier disc 1 one of the recesses 8 is carried out in such a way, that a centre of such a recess 8 is located at a radial going through the carrier disc 1 centre, as it is performed by the embodiments illustrated in FIG. 1, FIG. 2, FIG. 4 and FIG. 5. By a larger number of segments 2, usually seven and more, the driver 6 outside contour edges are cut off, as shown on FIG. 1 and FIG. 2. By a small number of the segments 2, the inside edge 13 of the lamella 3 is of an arc shape for a better fit under the central holding means.

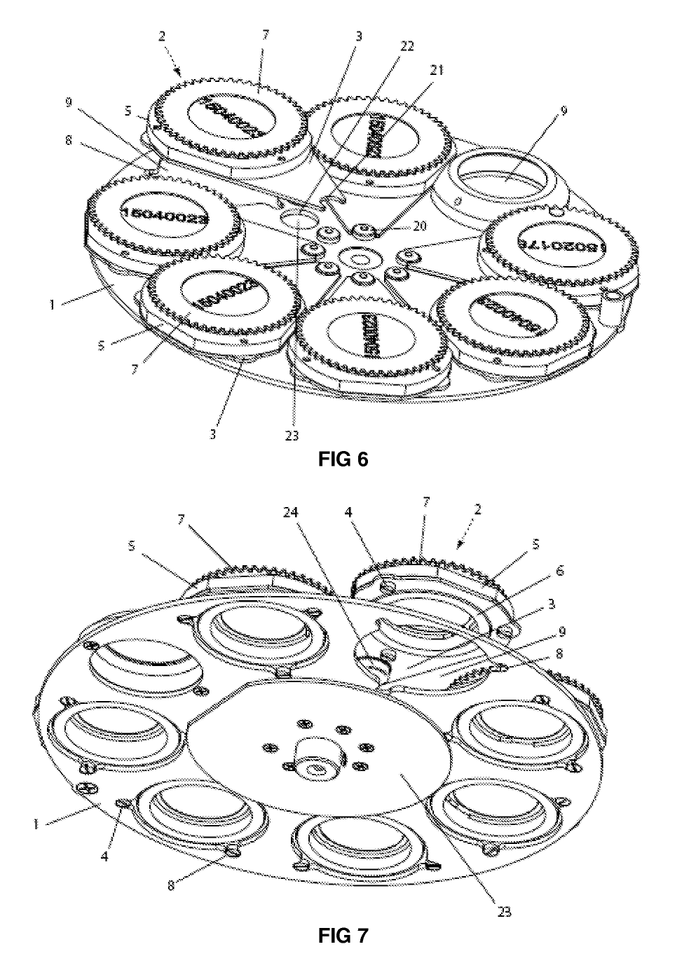

FIG. 6 and FIG. 7 illustrate another embodiment of a rotating gobo carrier wheel where the retention of the segment onto the carrier is achieved through magnetic attraction. FIG. 6 provides a top perspective view and FIG. 7 provides a bottom perspective view. The segment 2 is made of a lamella 3, shaped for registration and attachment of the segment 2 by a magnetic holding means 24. The gobo is fixed in a driver 6 seating in ball bearing. Bearing connection means, like screws 4 with cylindrical head in the depicted embodiment, serve for securing a ball bearing outside ring 5 on the lamella 3 of each segment 2. The bearing balls are freely located in the bearing outside ring 5, while the bearing inside ring is provided for by a driver 6 outer rim. The driver 6 is provided with a flange Z having a spur toothing/teeth for engagement with a mechanism for rotation of the gobos.

The bearing connection screws serve a second function: to register the position of the segments when installed on a carrier disc. It is important to note that these screws do not hold the segments to the carrier disc. To achieve a proper position of the segment 2 on the carrier disc 1 the screw 4 heads match with recesses 8 made along a perimeter of respective aperture 9 in the carrier disc 1 together serving to register the position of the segment on the carrier. In the embodiment shown on FIG. 6 and FIG. 7 there are three registration screw heads 4 for each segment 2 and therefore each aperture 9 has three recesses 8 distributed along its perimeter and spaced apart with respect to distribution of the registration screw heads 4. There may be used a different number of the registration screw heads 4, but basically two are sufficient. Instead of the above-described construction the means for registering a segment 2 on the carrier disc 1 may be provided for also by another means known as such—for example pegs or slots and non-concentric inserts.

The magnetic holding means comprise a ferrous plate 23 mounted underneath the carrier plate 1 with a hole 22 in the carrier plate 1 exposing a portion of the ferrous plate 23. Carrier plate 1 is typically constructed of a non ferrous non-magnetic material such as aluminum. In addition alignment pins 20 are attached to carrier plate 1. In the embodiment shown, the number of alignment pins 20 and holes 22 corresponds to the number of segments 2. Further the segment 2 has a magnet 24 mounted underneath the lamella 3 such that the magnet passes through the hole 22 in the carrier plate 1 and attaches to the ferrous plate 23. The magnetic attraction between magnet 24 and ferrous plate 23 securely retains the segment in position on the carrier. Magnet 24 may be of the same size and shape as the hole 22 such that there is a close alignment between the magnet 24 and the hole 22. In an alternate embodiment magnet 24 is smaller than hole 22 such that alignment screws 4 provide alignment of the segment by engaging in recesses 8. Magnet 24 may be a rare earth magnet or constructed of other magnetic material well known in the art. Lamella 3 may have an indentation 21 at its inner end which serves to engage with alignment pin 20 and assist with the positioning and alignment of the segment onto the carrier.

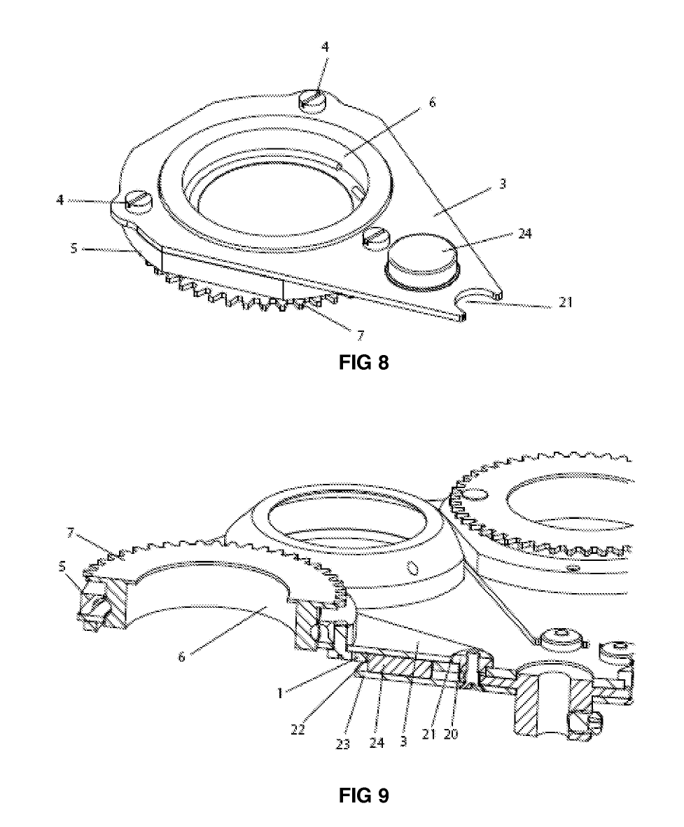

FIG. 8 illustrates the detail of the underneath of a single segment with its lamella 3, position registration screw heads 4, magnet 24 and alignment indentation 21. FIG. 9 is a cross section through the assembly showing how the magnet 24 passes through the hole 22 in the carrier plate 1 to engage with the ferrous plate 23.

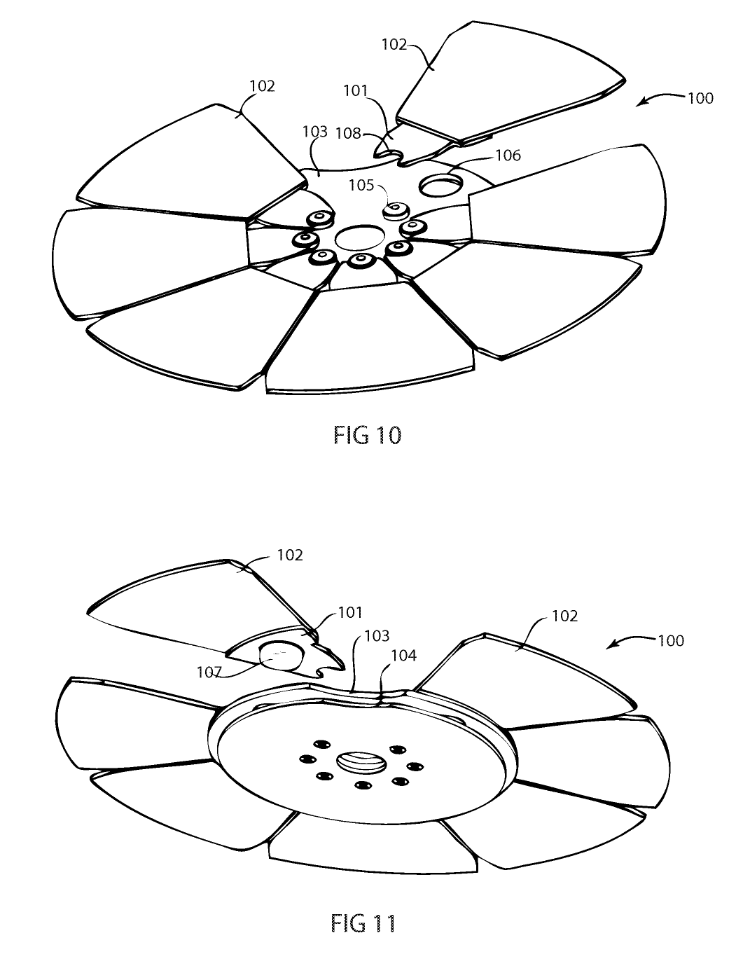

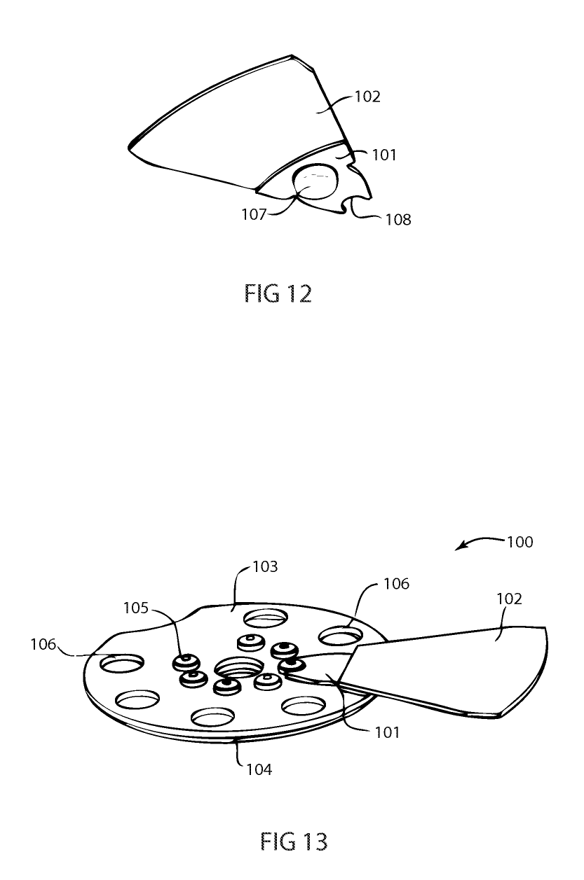

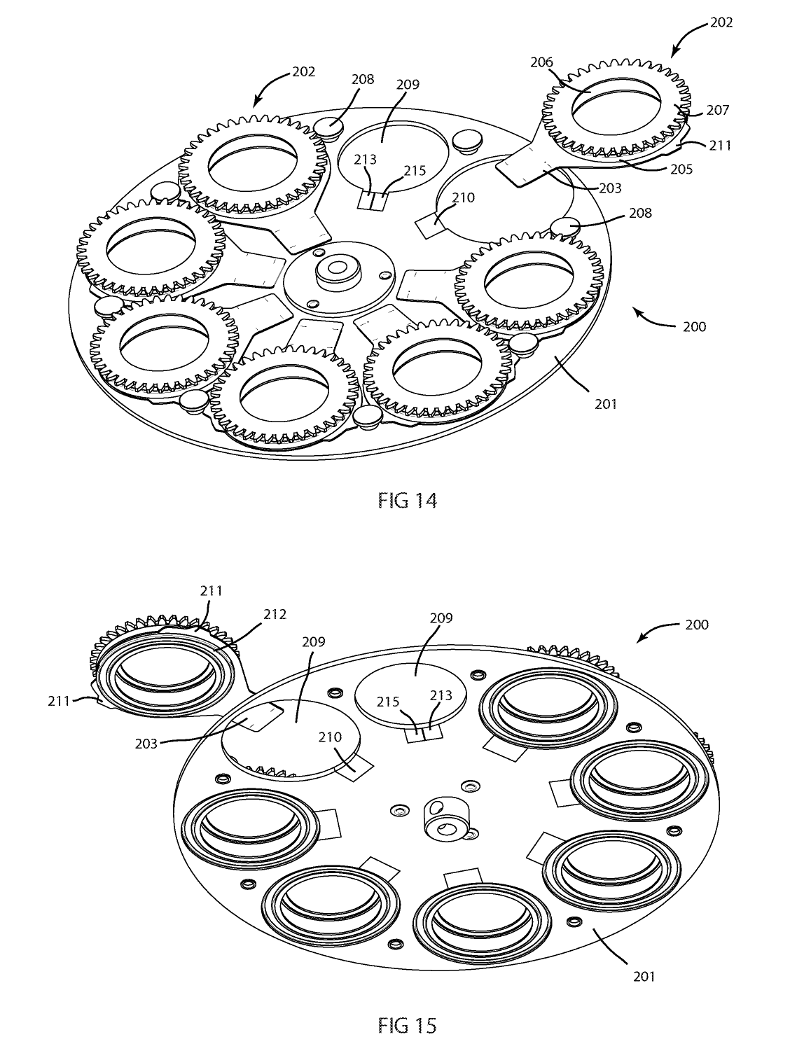

FIG. 10, FIG. 11, FIG. 12 and FIG. 13 illustrate a yet further embodiment of the invention. In this variant the segments do not carry gobos but instead carry filter material or other optical device such as lenses, frost or effects glasses. The filter material may be dichroic glass, colored glass or other colored material well known in the art. Filter material 102 is attached to lamella 101 which, in turn, has a magnet 107 attached to its underside. The main carrier plate 103 has a series of holes 106 through which the magnets 107 can pass and attach to the ferrous plate 104 which is affixed to carrier plate 103. The lamella 101 may have an indentation 108 at its inner end which serves to engage with alignment pin 105 and assist with the positioning and alignment of the segment onto the carrier. This system has the further distinction of not requiring a full size carrier plate 103. This allows the filter material segments 102 to be mounted adjacent to one another with no frame or border between adjacent segments. The alignment provided by indentation 108 and alignment pin 105 is adequate for this requirement.

FIG. 14 and FIG. 15 illustrate a further embodiment 200 where the retention of the segment 202 onto the carrier plate 201 is achieved through magnetic attraction. FIG. 14 provides a top perspective view and FIG. 15 provides a bottom perspective view. The segment 202 is made of a lamella 203, shaped for registration and attachment of the segment 202 through a magnetic holding means 210. The gobo is fixed in a geared driver seating 206 supported by a ball bearing race (not shown). The bearing balls (not shown) are freely located in the bearing inside ring 205, while the bearing inside ring is provided for by the outer rim of geared driver seating 206. The geared driver 206 is provided with a flange 207 having spur gear teeth for engagement with a mechanism for rotation of the gobos. The segment 202 may be aligned and prevented from rotation by optional guide pins 208. First and second tabs 211 on the sides of lamella 203 engage with a shoulder on guide pin 208. Although not necessary during normal operation such engagement with first and second tabs 211 serves to both guide and assist insertion of the segment and to prevent excessive movement of segment 202 in both a lateral and vertical direction with respect to carrier plate 201 if the unit is heavily jarred during shipping. In the embodiment disclosed in FIG. 14 and FIG. 15 there are the same number of guide pins 208 as apertures 209.

Primary lateral alignment is provided by the bearing sleeve 212. Bearing sleeve 212 protrudes from the underside of the lamella 203 on the rear side of segment 202 and engages with aperture 209 in the carrier plate 201; this coupling provides accurate alignment of segment 202 with carrier plate 201 in all lateral directions. The alignment of bearing sleeve 212 with aperture 209 combined with the optional back-up of engagement of first and second tabs 211 with guide pins 208 provides accurate and robust alignment of the segment to the carrier plate in all planes and ensures accurate registration and focus of the gobo image.

The magnetic holding means comprise a ferrous lamella 203 and a magnet 210 mounted to the carrier plate 201. Carrier plate 201 is typically constructed of a non ferrous non-magnetic material such as aluminum. In operation the ferrous lamella 203 is attracted to magnet 210 while being further constrained by guide pins 208 and tabs 211 so as to securely retain the segment in position on the carrier. Magnet 210 may be a rare earth magnet or constructed of other magnetic material well known in the art. Magnet 210 may be a single magnet or may be a pair of adjacent magnets 213, 215 presented in magnetic opposition such that a magnetic circuit is provided through the ferrous lamella 203 thus providing increased attractive force.

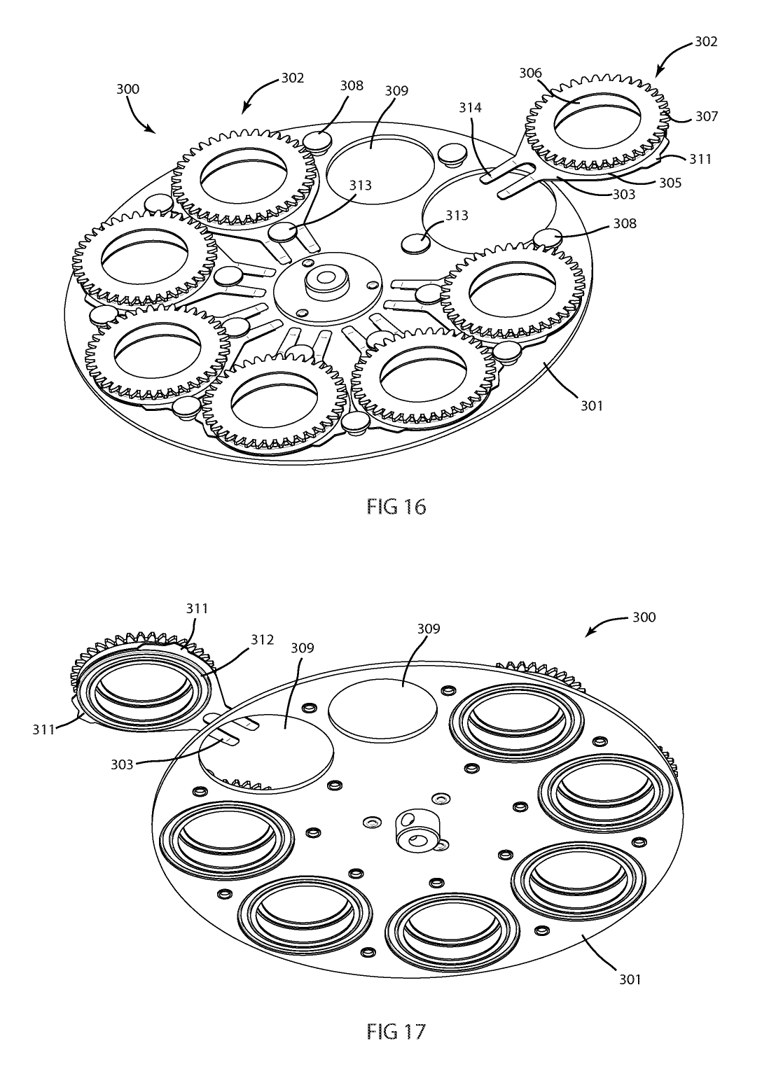

FIG. 16 and FIG. 17 illustrate a different class of embodiments of a rotating gobo carrier wheel 300 where the retention of the segment 302 onto the carrier is achieved through a forked spring 214. FIG. 16 provides a top perspective view and FIG. 17 provides a bottom perspective view. The segment 302 is made of a lamella 303, shaped for registration and attachment of the segment 302 through a forked spring holding means to guide pin 313. The gobo is fixed in a geared driver seating 306 supported by a ball bearing race. The bearing balls are freely located in the bearing inside ring 305, while the bearing inside ring is provided for by the outer rim of geared driver seating 306. The geared driver 306 is provided with a flange 307 having spur gear teeth for engagement with a mechanism for rotation of the gobos. The segment 302 may be aligned and prevented from rotation by optional guide pins 308. First and second tabs 311 on the sides of lamella 303 engage with a shoulder on guide pin 308. Although not necessary during normal operation such engagement with first and second tabs 311 serves to both guide and assist insertion of the segment and to prevent excessive movement of segment 302 in both a lateral and vertical direction with respect to carrier plate 301 if the unit is heavily jarred during shipping. In the embodiment disclosed in FIG. 16 and FIG. 17 there are the same number of guide pins 308 as apertures 309. Primary lateral alignment is provided by the bearing sleeve 312. Bearing sleeve 312 protrudes from the underside of the lamella 303 on the rear side of segment 302 and engages with aperture 309 in the carrier plate 301; this coupling provides accurate alignment of segment 302 with carrier plate 301 in all lateral directions. The alignment of bearing sleeve 312 with aperture 309 combined with the optional back-up of engagement of first and second tabs 311 with guide pins 308 and forked spring 314 with guide pin 313 provides accurate and robust alignment of the segment to the carrier plate in all planes and ensures accurate registration and focus of the gobo image.

The forked spring holding means comprise a two fingered forked spring 314 and a central guide pin 313 mounted to the carrier plate 301. Guide pin 313 has a central pin surmounted by a cap that is of larger diameter than the central pin. The underside of the cap is separated from the carrier plate 301. In operation the two fingers of forked spring 314 is slid under the cap and around the central pin of guide pin 313. Forked spring 314 has a preformed bend towards from the carrier plate such that the fingers of said forked spring require pressure so as to slide under the cap of guide pin 313. As the segment is slid inwards with the forked spring under the cap of guide pin 313 the bearing sleeve 312 will drop into aperture 309 securely retaining segment 302 by pressure between the underside of the guide pin cap and forked spring 314.

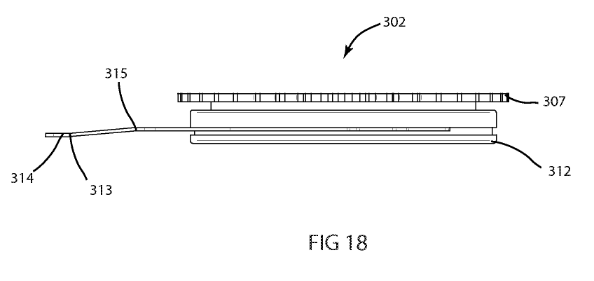

FIG. 18 shows an elevation of a removable segment 302 illustrating the forked spring 314 and the bend 315 in the forked spring.

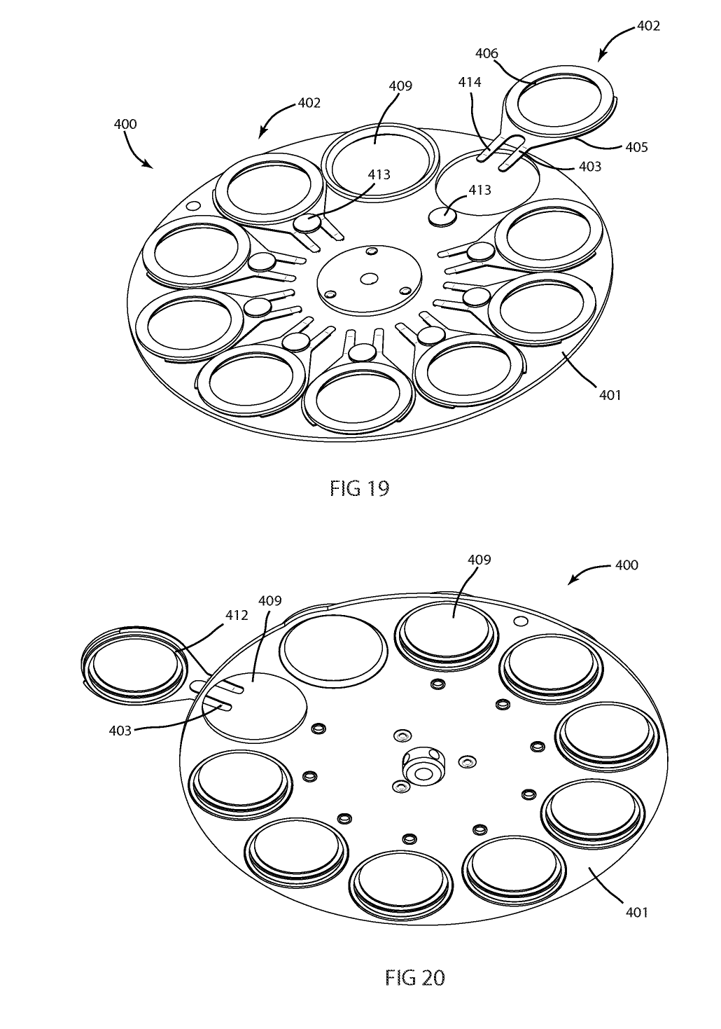

FIG. 19 and FIG. 20 illustrate a further embodiment of the invention where the retention of the segment carrying a fixed, non rotating gobo, onto the carrier is achieved through a forked spring. FIG. 19 provides a top perspective view and FIG. 20 provides a bottom perspective view. The segment 402 is made of a lamella 403, shaped for registration and attachment of the segment 402 through a forked spring holding means 414 to guide pin 413. The gobo is fixed in a seating ring 406. The seating ring 406 is retained within the curved arms 405 of lamella 403. The segment 402 is aligned and prevented from rotation by central guide pin 413. Such engagement prevents movement of segment 402 in both a lateral and vertical direction such that segment 402 is constrained in an accurate position with respect to carrier plate 401. In the embodiment disclosed in FIG. 19 and FIG. 20 there are one less central guide pins 308 than apertures 309 so as to provide a single permanently open aperture. Further alignment is provided by the sleeve 412. Sleeve 412 protrudes from the underside of the lamella 403 on the rear side of segment 402 and engages with aperture 409 in the carrier plate 401; this coupling provides accurate alignment of segment 402 with carrier plate 401 in all lateral directions. The alignment of sleeve 412 with aperture 409 combined with the engagement of forked spring 414 with central guide pin 413 provides accurate and robust alignment of the segment to the carrier plate in all planes and ensures accurate registration and focus of the gobo image.

The forked spring holding means comprise a two fingered forked spring 414 and a central guide pin 413 mounted to the carrier plate 401. Guide pin 413 has a central pin surmounted by a cap that is of larger diameter than the central pin. The underside of the cap is separated from the carrier plate 401. In operation the two fingers of forked spring 414 is slid under the cap and around the central pin of guide pin 413. Forked spring 414 has a preformed bend towards from the carrier plate such that the fingers of said forked spring require pressure so as to slide under the cap of guide pin 413. As the segment is slid inwards with the forked spring under the cap of guide pin 413 the sleeve 412 will drop into aperture 409 securely retaining segment 402 by pressure between the underside of the guide pin cap and forked spring 414.

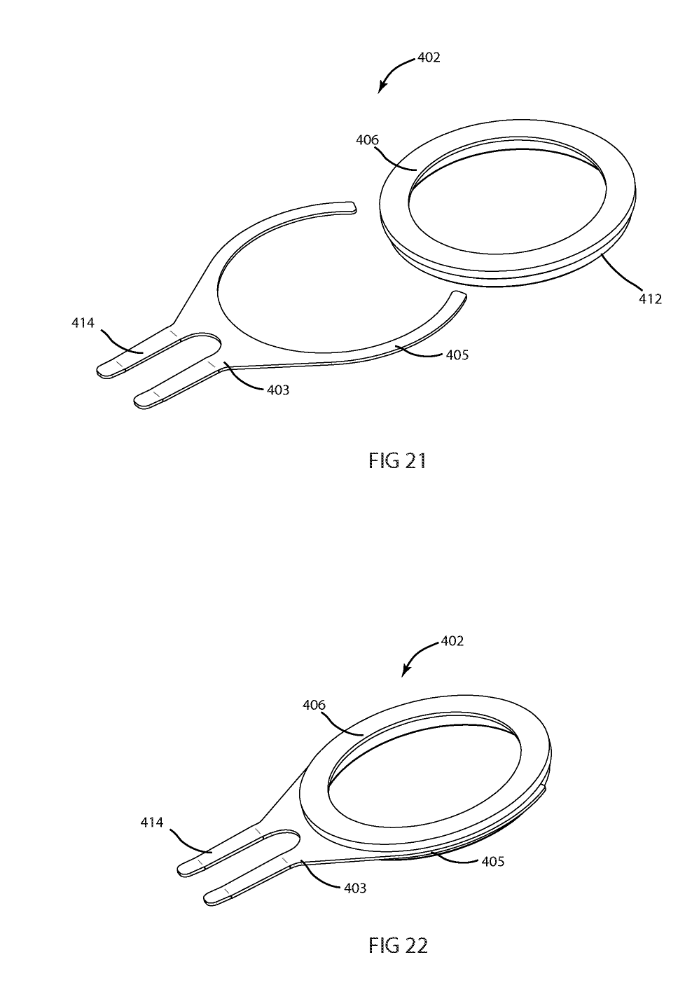

FIG. 21 and FIG. 22 show perspective views of a removable segment 402 illustrating the snap-in attachment of the seating ring 406 into the forked spring 405.

It should be appreciated by those skilled in the art that the quick-change gobo changer systems described above can be changed without removing the gobo carrier from the automated luminaire without handling the gobos directly and without the use of tools and can be done very quickly by hand.

In other embodiments rather than having a slot in the gobo segment spring lamella, the slot(s) is located in the central pin and the gobo segment spring labella slides into and registers in such slot(s) The central pin for each gobo segment may have one or more such slots to mate with one or more lamella extensions.

While the invention has been described with respect to a limited number of embodiments, those skilled in the art, having benefit of this invention, will appreciate that other embodiments may be devised which do not depart from the scope of the invention as disclosed herein. Accordingly, the scope of the invention should be limited only by the attached claims.

The invention has been described in detail, it should be understood that various changes, substitutions and alterations can be made hereto without departing from the spirit and scope of the invention as described by the appended claims.

What is claimed is:

1. A luminaire with a light source from which a beam of light is projected comprising:
a gobo carrier for supporting a plurality of gobo segments for placing gobos into the light beam; and
spring gobo segments registering a gobo segment in a fixed position on the gobo carrier and securing the gobo segment on the gobo carrier; and
registration tab(s) against which the segment springs register.

2. The luminaire of claim 1 wherein the registration tab(s) reside on the gobo carrier.

3. The luminaire of claim 2 wherein the gobo segments have at least one protruding slot that registers against a tab residing on the gobo carrier.

4. The luminaire of claim 3 wherein at least one of tabs for each gobo segment is centrally located such that they engage the gobo segment slot as the gobo segment is installed toward a center of the gobo carrier.

5. The luminair of claim 3 wherein the gobo carrier has at least two other tabs against which each gobo segment position is registered.

6. The luminair of claim 3 wherein the tabs against which each gobo segment position is registered prevent both lateral and rotational movement during operation and/or transport.

7. The luminair of claim 3 wherein
the gobo carrier has apertures; and
the gobo segments hold the gobos with sleeves that register in the gobo carrier apertures registering the position of the gobo segments and prevent lateral movement during operation and/or transport.

8. The luminaire of claim 1 wherein the gobo segments neighbor one another and serve as registration tabs for neighboring gobo segments.

9. A luminaire with a light source from which a beam of light is projected comprising:
a gobo carrier for supporting a plurality of gobo segments for placing gobos into the light beam; and
spring rotating gobo segments registering a gobo segment in a fixed position on the gobo carrier and securing the gobo segment on the gobo carrier and allowing for rotation of the gobo once in position on the gobo carrier; and
registration tab(s) against which the segment springs register.

10. The luminaire of claim 9 wherein the registration tab(s) reside on the gobo carrier.

11. The luminaire of claim 10 wherein the gobo segments have at least one protruding slot that registers against a tab residing on the gobo carrier.

12. The luminaire of claim 11 wherein at least one of tabs for each gobo segment is centrally located such that they engage the gobo segment slot as the gobo segment is installed toward a center of the gobo carrier.

13. The luminair of claim 11 wherein the gobo carrier has at least two other tabs against which each gobo segment position is registered.

14. The luminair of claim 11 wherein the registration tabs against which each gobo segment position is registered prevent both lateral and rotational movement during operation and/or transport.

15. The luminair of claim 11 wherein
the gobo carrier has apertures; and
the gobo segments hold the gobos with sleeves that register in the gobo carrier apertures registering the position of the gobo segments and prevent lateral movement during operation and/or transport.

16. A luminaire with a light source from which a beam of light is projected comprising:
a gobo carrier for supporting a plurality of gobo segments for placing gobos into the light beam which hold a plurality of rigid tabs; and
elongaged spring gobo segments which hold gobos on one section and have engage the gobo carrier rigid tabs on an elongated spring section.

17. The luminaire of claim 16 wherein
the elongated spring section has slot(s) forming a fork with which to engage a gobo carrier tab.

18. The luminaire of claim 16 where the rigid tab has a slot into which the elongated spring section of the gobo segment is engaged.

19. The luminaire of claim 16 where the elongated spring gobo segments hold rotating gobos.

20. The luminaire of claim 16 wherein the gobo carrier has at least two other tabs against which each gobo segment position is registered.

21. The luminair of claim 21 wherein the registration tabs against which each gobo segment position is registered prevent both lateral and rotational movement during operation and/or transport.
